(19) United States
(12) Patent Application Publication
(10) Pub. No.: US 2003/0014366 A1
(43) Pub. Date: Jan. 16, 2003

(54) Rental system of software through internet

(76) Inventor: Gil Lim Yoon, Kyunggi-do (KR)

Correspondence Address: BACON & THOMAS, PLLC, 625 SLATERS LANE, FOURTH FLOOR, ALEXANDRIA, VA, 22314

(21) Appl. No.: 10/110,790

(22) PCT Filed: Jul. 16, 2001
(86) PCT No.: PCT/KR01/01218

(51) Int. Cl. G06F 17/60

(52) U.S. Cl. 705/50

(57) ABSTRACT

The invention relates to a rental system of software through Internet. The system includes a server (4) provided only with the solver modules (10) and the computer terminals (6) provided with pre-processor modules (8) and post-processor modules (12) of the softwares (8,10.12), in such a manner that inputting of data in the pre-processor module (8) at a computer terminal (6), and accessing to the internet server (4) through internet and then transmission of the customer's ID and password through the computer terminals (6) by the action of a user cause the mutual communication between the computer terminal (6) and the server (4), with the result that the solver module (10) processes the data input in the pre-processor (8) and transfers the result of the operation to the computer terminal (6), and then the post-processor module (12), on the other hand, transforms the result of the operation received into a diagram or graph or displaying on the monitor of the computer terminal (6).

### FIELD OF THE INVENTION

The present invention relates to a rental system of software through internet, and more particularly to a rental system of software through the use of internet so devised as to allow the rental use of the desired software by accessing the internet server provided with a software through internet.

### FIELD OF THE INVENTION

In recent years, various kinds of engineering application softwares or programs have been developed to solve complicated mathematical equations by using computers, as the computer technology develops. These application softwares may consist of three major modules; a pre-processor modules which allow users to input basic data, a solver modules which process the data input at the pre-processor modules and a post-processor modules which function to output the result processed at the solver modules in the form of numeric, graphs, tables or computer graphics to display them on monitors or screens.

The pre-processor modules, solver modules and post-processor modules in engineering softwares have their own independent process functions. Thus, when users input data in the pre-processor modules through the interfaces of pre-processor modules, the solver modules receive the data input in the pre-processor modules, and then transfer the processed results to the post-processor modules after conducting the process operations. The post-processor modules process the data processed at the solver modules according to pre-prescribed manner, wherein numeric, tables or computer graphics are displayed in a such a manner that the users may understand the results of processed data with ease. The pre-processor, solver and post-processor modules may be either caused to function as a full software by preparing them separately and subsequently incorporating them, or those modules prepared by different manufacturers may be put into one unit as an integrated application software.

As such engineering application softwares can output data in such a variety of ways that the users may make a easy use of the output data, the use of the softwares is on the steep rise recently.

However, most users have problems procuring such engineering softwares because they are very expensive to purchase. Thus, ordinary users take the way of renting the engineering softwares to be installed on their own computers for a certain period instead of directly purchasing the softwares. However, in general, engineering softwares, especially solver-module includes so tremendous operation quantity that they can not be handled using a personal computer(PC) and it needs to use the high-performance computers with a high processing speed. Accordingly, even in case of renting softwares purchasing of high-performance computers is either needed, or burden of spending expensive cost for renting should be assumed, and in this connection there is another problem that the rental cost should rather be paid depending on the renting period of time irrespective of the actual times of use for the softwares.

Such a problem takes place as well in other cases of using all sorts of softwares involving a large operation quantity such as computer graphics(CG) softwares or the like not just for the engineering softwares as described above. On the other hand, as the internet keeps developing lately, reciprocal data communication is made possible by connecting the high-performance internet server with individual computers through internet.

### SUMMARY OF THE INVENTION

The present invention was created to resolve the above-described problems, and thus the object of the invention is to provide a rental system of softwares through internet based on a new conception by the assistance of which users can use application softwares with their own computers without purchasing of separate high-performance computers or application softwares.

The above object is resolved according to an aspect of the invention by the rental system of software through internet, for renting to users the softwares(8,10,12) each comprising a pre-processor module(8) for allowing the users to input data, a solver module(10) for conducting operations of the data input in the pre-processor module(8) based on the formulae input already, and a post-processor module(12) for displaying the result of the operations at the solver module(10) in the form of numeric, graph, table or computer graphics, wherein the system includes a server(4) provided with a data base(2) having the ID's or passwords of customers or users stored therein, the customers having subscribed for the software rental service, and computer terminals(6) for allowing the customers to conduct data communications by accessing the server(4) through internet, and wherein the server(4) is provided only with the solver modules(10) of the softwares(8,10,12) and the computer terminals(6) are provided with the pre-processor modules(8) and post-processor modules(12) of the softwares(8,10,12), in such a manner that inputting of data in the pre-processor module(8) at a computer terminal(6), and accessing to the internet server(4) through internet and then transmission of the customer's ID and password through the computer terminals(6) by the action of a user cause the mutual communication between the computer terminal(6) and the server(4), with the result that the solver module(10) processes the data input in the pre-processor(8) and transfers the result of the operation to the computer terminal(6), and then the post-processor module(12), on the other hand, transforms the result of the operation received into a diagram or graph for displaying on the monitor of the computer terminal(6).

According to another aspect of the invention, there is provided a rental system of softwares through internet, for renting to users the softwares(8,10,12) each consisting of a pre-processor module(8) for allowing the users to input data, a solver module(10) for conducting operation of the data input in the pre-processor module(8) based on the formulae input already, and a post-processor module(12) for displaying the result of the operation at the solver module(10) in the form of numeric, graph, table or computer graphic, wherein the system includes a server(4) provided with a data base(2) having the ID's or passwords of customers stored therein, the customers having subscribed for the rental service of engineering softwares, and computer terminals(6) for allowing the customers to conduct data communications by accessing the server(4) through internet, and wherein the server(4) is provided with the solver modules(10) and post-processor modules(12) of the softwares(8,10,12), and the computer terminals(6) are provided with pre-processor modules(8), in such a manner that input of data in the pre-processor module(8) at a computer terminal(6), access to the internet server(4) through internet, and then transmission of the customer's ID and password through the computer terminals(6) by the action of a user cause a mutual communication between the computer terminal(6) and the server(4), with the result that the solver module(10) processes the data input in the pre-processor(8) and transfers the result of the operations to the computer terminal(6), and then the post-processor module(12), on the other hand, transforms the results of the operation received into a diagram or graph for displaying on the monitor of the computer terminal(6).

### BRIEF DESCRIPTION OF THE DRAWINGS

FIG. 1 shows a arrangement of a rental system of softwares through internet according to a preferred embodiment of the invention and

FIG. 2 shows a flow chart for the rental system of softwares through internet shown in FIG. 1.

### DETAILED DESCRIPTION OF THE INVENTION

A preferred embodiment of the invention is described in detail below by referring to the accompanying drawings.

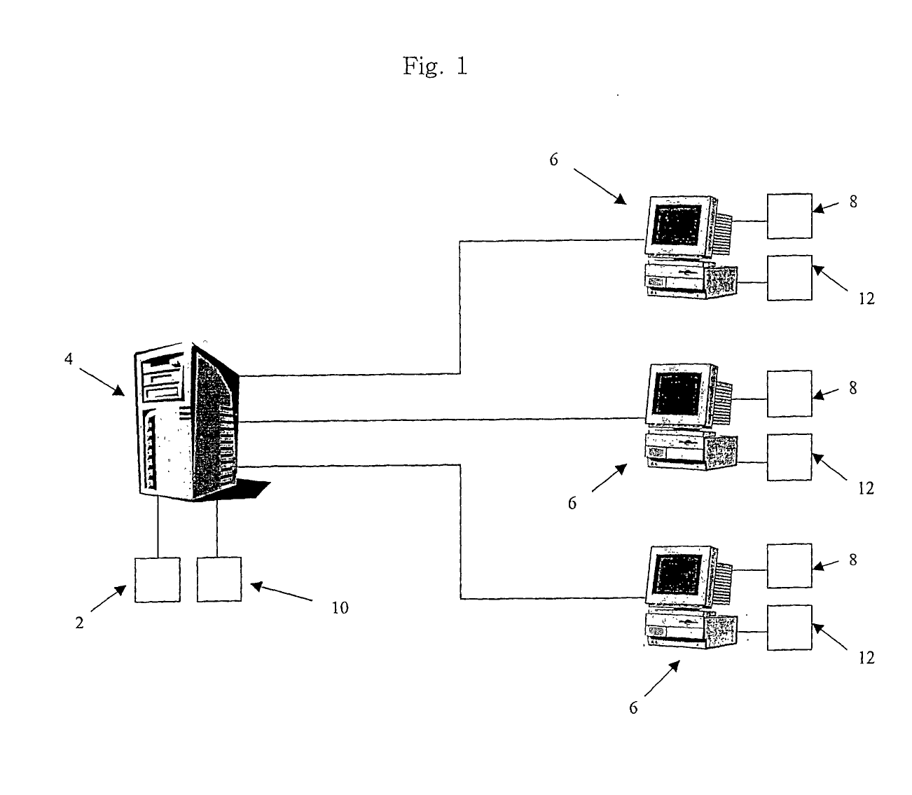

FIG. 1 shows the rental system of softwares to a preferred embodiment of the invention, in which system respective modules of engineering softwares 8, 10 and 12 each consisting of a pre-processor module 8, server module 10 and post-processor module 12 are disposed separately between the internet server 4 and personal computer terminals 6 as the clients, so that customers may use engineering softwares with ease, wherein the pre-processor module 8 is intended for data inputting, the solver module 10 functions to perform a operation for the data input in the pre-processor module 8 and the post-processor modules 12 functions to display the operation result from the solver module 10 in numeric, graph, table or computer graphics.

This rental system of softwares is composed of a server 4 provided with a data base 2 and computer terminals 6 on the side of customers for accessing the server 4 through internet, so as to enable the mutual communicating between the server 4 and computer terminals 6, as is the case for the general internet communicating system. Preferably, as the server 4, a high-performance computer such as the supercomputer, which can handle engineering softwares involving a great deal of operations, may be used. In the data base 2 of the server 4, the ID's and passwords who have subscribed for the rental service as members are stored. Thus, if only the customers who have accessed the server 4 by using the computer terminals 6 have entered their ID's and passwords, they are qualified to use engineering softwares 8, 10 and 12 provided in the server 4.

Furthermore, the pre-processor modules 8 and post-processor modules 12 of engineering softwares 8, 10 and 12 are provided in the computer terminals 6 of customers, while only the solver modules 10 performing actual operations are provided in the server 4. In particular, the pre-processor and post-processor modules 8 and 12 are delivered to customers in the form as stored in the storage media such as CD's or otherwise they may be installed in the computer terminals of customers after downloading through internet. Further, preferably the pre-processor and post-processor modules 8 and 12 are provided with the function of web-browser to enable the access to the server 4 through internet, so that the ID's and passwords of customers input beforehand by customers may be automatically transmitted to the server 4, when the connection is made to the server 4 through internet. Additionally, the server 4 is provided with a software to check the access period for which customers were in access with the server 4 through the computer terminals 6.

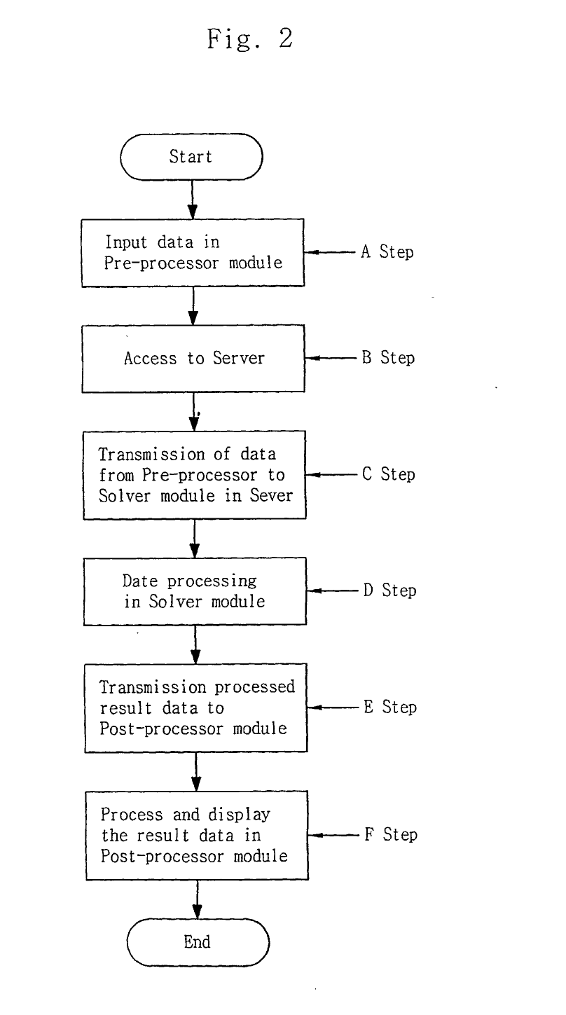

Therefore, as shown in FIG. 2, when a customer inputs data in the pre-processor module 8 provided in his computer terminal 6 at Step A, and access to the server 4 is made at Step B, the mutual communication between the computer terminal 6 and the server 4 causes the transmission of the data input in the pre-processor module 8 to the solver module 10 provided in the internet server 4 at Step C. At this time, the customer may not have to input the ID and password separately, by inputting and storing his ID and password in the pre-processor module 8 beforehand. The solver module 10 conducts a operation on the data having been input through the pre-processor module 8 at Step D, and transmits the operation data as the processed result to the computer terminal 6 at Step E. Subsequently, the post-processor module 12 provided in thee computer terminal 6 processes the received operation data to be output in the form as designated by the customer like numeric, graph, table or computer graphics to a monitor or printer at Step F.

A manager in charge of supervising the internet server 4 can charge the customer with the rental fee for the use of softwares depending on the period of the operation conducted by the solver module 10 in response to the data input by the customer, by checking the duration of access to the server 4 by the customer.

The rental system of softwares by using internet arranged as described above has the advantage, in the respect of cost, that high-performance computers need not be provided and expensive application softwares need not be purchased, because the solver modules 10 calling for high-performance computers are provided in the server 4, and the computer terminals of customers are provided only with the pre-processor and post-processor modules 8 and 12 needing relatively a small operating capacity. Further, the rental fee for software use can be remarkably reduced in comparison with the conventional manner based on the period of rent, as fee may be paid only based on the actual period of time during which the customers used engineering softwares online.

The accessing period for the internet server 4 or effective counted period can be minimized, on the ground that the customers make access to the internet server 4 after they input data beforehand by using the pre-processor modules 8 provided in their own computers. Further, overload on the internet server 4 due to simultaneous accesses of many users can be greatly relieved. Particularly, the reduction in time for users to access the server 4 allows the reduction in the number of interface lines for customers or the number of nods provided in the server 4, decreasing the cost in connection with acquisition of nods.

There is another advantage of the free or unrestricted use of operation results, because users can cause the data output from the solver module 10 to be displayed in the form as they desire by using the post-processor modules 12, which are provided in their computer terminals 6.

While an embodiment of software rental system for renting engineering softwares usable to compute engineering or mathematical formulae was illustrated, such a rental system can be applied, beside the above-described engineering software, to all sorts of application softwares consisting of the pre-process, solver and post-processor modules and conducting a great deal of operations.

As described above, the present invention provides a rental system of software by using internet, wherein customers can use the software including engineering softwares which would otherwise require high-performance computers by using their own computers without the need for purchasing the high-performance computers and expensive softwares, through the measure of providing the internet server with application softwares and installing the respective modules composing application softwares distributedly in the internet server and in personal computer terminals as clients.

1. A rental system of softwares through internet, for renting to users the softwares(8,10,12) each consisting of a pre-processor module(8) for allowing the users to input data, a solver module(10) for conducting operations of the data input in the pre-processor module(8) based on the formulae input already and a post-processor module(12) for displaying the result of the operations at the solver module(10) in the form of numeric, graph, table or computer graphic, wherein the system includes a server(4) provided with a data base(2) having the ID's or passwords of customers stored therein, the customers having subscribed for the rental service of software, and computer terminals(6) for allowing the customers to conduct data communications by accessing the server(4) through a internet, and wherein the server(4) is provided only with the solver modules(10) of the softwares(8,10,12) and the computer terminals(6) are provided with pre-processor modules(8) and/or post-processor modules(12) of the softwares(8,10,12), in such a manner that input of data in the pre-processor module(8) at a computer terminal(6), access to the internet server(4) through a internet and then transmission of the customer's ID and password through the computer terminals(6) by the action of a user cause the mutual communication between the computer terminal(6) and the server(4), with the result that the solver module(10) processes the data input in the pre-processor(8) and transfers the result of the operation to the computer terminal(6), and then the post-processor module(12), on the other hand, transforms the result of the operation received into a diagram or graph for displaying on the monitor of the computer terminal(6).
